(19) United States
(12) Patent Application Publication
(10) Pub. No.: US 2010/0056039 A1
(43) Pub. Date: Mar. 4, 2010

(54) DRIVE SYSTEM FOR A FIRE PROTECTION FLAP

(75) Inventors: Beat Weber, Zurich (CH); Ralf Kastle, Zurich (CH)

Correspondence Address: SUGHRUE MION, PLLC, 2100 PENNSYLVANIA AVENUE, N.W., SUITE 800, WASHINGTON, DC, 20037, US

(73) Assignee: Belimo Holding AG, Hinwil (CH)

(21) Appl. No.: 12/595,019

(22) PCT Filed: Apr. 2, 2008
(86) PCT No.: PCT/EP08/53951

§ 371 Date: Oct. 7, 2009

(30) Foreign Application Priority Data
Apr. 12, 2007 (CH) 0604/07

(51) Int. Cl. A62C 2/12

(52) U.S. Cl. 454/369

(57) ABSTRACT

The invention relates to a drive system (A) for a fire protection flap (8) arranged in a ventilation duct (9). Said drive system (A) comprises at least one drive element (1), an energy supply element (2) for supplying energy to the drive element (1) and a mechanical load-torque lock (3) for absorbing a torque acting on the fire protection flap (8). The drive element (1) is made essentially of plastic. A thermal protection element (4) is at least arranged on the side of the drive element (1) which faces the ventilation duct (9).

### TECHNICAL FIELD OF THE INVENTION

The present invention is concerned with the field of drives and of drive systems for fire protection flaps in a ventilation duct. It relates to a drive system for a fire protection flap according to the features of the preamble of claims 1, 6 and 10.

### PRIOR ART

Drives and drive systems for fire protection flaps which are arranged, for example, in a ventilation duct of an air conditioning system or ventilation system are known from the prior art.

For example, EP 1 519 120 shows a drive system for an electrically driven fire protection flap. The fire protection flap can be installed or removed with the drive fitted. In this case, the fire protection flap can be connected to two spindle end pieces via a plug-in connection. The drive system comprises a motor which is connected via a transmission to a load moment block. The load moment block absorbs forces acting on the fire protection flap in the event of a fire, i.e. when the fire protection flap is closed. Furthermore, the drive system has a spring return which automatically closes the flap leaf when the power supply is interrupted.

Since such drive systems for fire protection flaps are produced in a high piece number, the rather complicated construction of the drive system may have a negative effect on the production costs.

In particular, it is pointed out that many drive systems from the prior art have a large number of metallic components. Said components are in particular typically manufactured from iron metals, such as, for example, steel, and are correspondingly expensive.

The drive systems of the prior art are typically arranged on the outer surface of a ventilation duct. Accordingly, the shaft of the flap spindle has to extend over the outer surface so that it can be connected to a drive. To install/remove a drive, sufficient space generally has to be created so that the installer has access to the individual fastening points. Furthermore, the installer customarily has to remove other components, such as, for example, the fire protection flap, in advance and re-attach them after the drive system has been installed. Furthermore, supply lines for supplying electric energy or control signals have to be fitted/removed during an installation/removal operation and re-tested. The installation operation and the removal operation of prior art drive systems therefore have the tendency to be complicated and therefore time-consuming.

The torsional locking means of prior art drive systems also frequently prove unreliable. Typically, a screw which is arranged as far as possible away from the point of rotation is used as the torsional locking means. Vibrations in the ventilation duct may cause the screw to be loosened. This has the consequence, when the drive is actuated, that the torque applied by the drive cannot be compensated for.

### SUMMARY OF THE INVENTION

It is therefore an object of the invention to configure a drive system to be as simple and cost-effective as possible and to be reliable in the operation thereof.

This object is achieved by a drive system with the features of patent claim 1.

According thereto, a drive system according to the invention for a fire protection flap arranged in a ventilation duct has at least one drive element, an energy supply element for supplying energy to the drive element, and a mechanical load moment block for absorbing a torque acting on the fire protection flap. The drive element is substantially made of plastic. A heat protection element is located on at least that side of the drive element which faces the ventilation duct.

The configuration of the drive element substantially from plastic is advantageous, since the corresponding plastic parts can be produced in a simple and therefore cost-effective manner. The action of heat on the drive in the event of a fire can be delayed by the arrangement of a heat protection element, and therefore the operation of the drive is ensured for a certain period of time, and the fire protection flap can be securely and reliably closed.

In addition, the plastic of the drive element begins to burn only at a relatively late point, if at all. The fire is therefore effectively prevented from spreading over the fire protection wall.

Further advantageous embodiments are characterized in the dependent claims.

Furthermore, it is a further object of the invention to provide a drive system which can be fitted as simply and securely against torsion as possible.

This object is achieved by a drive system with the features of patent claim 6.

According thereto, a drive system according to the invention for a fire protection flap arranged in a ventilation duct has at least one drive element, an energy supply element for supplying energy to the drive element, and a mechanical load moment block for absorbing a torque acting on the fire protection flap. A torsional locking element is fixedly connected to part of the drive element, it being possible for the torsional locking element to abut to an element which is connected to the ventilation duct, in order to secure the drive element against rotation.

The torsional locking element permits particularly simple installation and can particularly reliably oppose rotation arising due to the action of a torque.

Furthermore, it is a further object of the invention to provide a drive system which has an efficient and low-maintenance energy supply.

This object is achieved by a drive system with the features of patent claim 10.

According thereto, a drive system according to the invention for a fire protection flap arranged in a ventilation duct has at least one drive element, an energy supply element for supplying energy to the drive element, and a mechanical load moment block for absorbing a torque acting on the fire protection flap. The energy supply element is a supercapacitor.

### BRIEF DESCRIPTION OF THE DRAWING

The invention is described in more detail below with reference to the drawing, in which:

FIG. 1 shows a perspective view of a drive system according to the invention;

FIG. 2 shows a view of a detail of part of a drive system according to the invention;

FIG. 3 shows a sectional view of a drive system according to the invention with a heat protection element according to one embodiment;

FIG. 4 shows a sectional view of a drive system according to the invention with a heat protection element according to a further embodiment;

FIGS. 5a-c show a sectional view for illustrating the installation of a drive system according to the invention;

FIG. 6a shows a side view of part of a drive system according to the invention; and

FIG. 6b shows a top view of FIG. 6a.

### DESCRIPTION OF AN EXEMPLARY EMBODIMENT

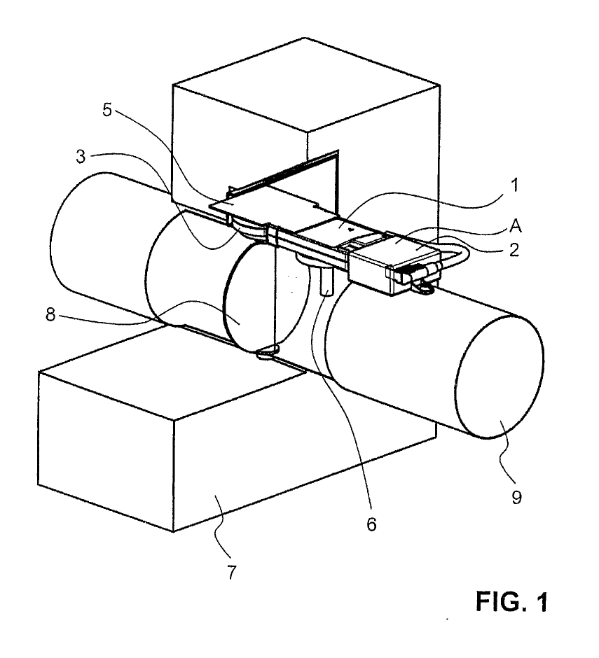

FIGS. 1, 2 and 3 show a configuration of a drive system A according to the invention or parts of a drive system A according to the invention for driving a fire protection flap 8. The fire protection flap 8 is arranged in a ventilation duct 9 which penetrates a wall 7. The drive system A according to the invention preferably comprises a drive element 1, an energy supply element 2 and a load moment block 3.

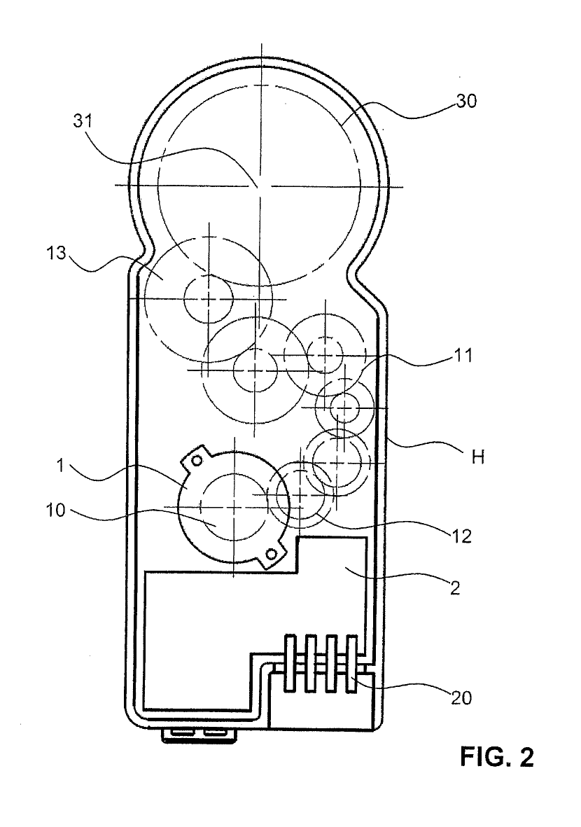

The drive element 1, as illustrated for example in FIG. 2, preferably comprises an electric motor 10 and a transmission 11 which is driven by the electric motor 10. The electric motor 10 passes a rotational movement into the transmission 11 via the transmission input side 12. The transmission output side 13 is connected to the gearwheel 30 which is also the input side of the load moment block. The load moment block 3 can be connected to the gearwheel 30 via the internal toothing 31.

The energy supply element 2 serves to store electric energy and to output the stored electric energy to the drive element 1 and to the electric motor 10. Accordingly, the electric motor 10 is supplied with electric energy by the energy supply element 2. The energy supply element 2 can be charged with electric energy by an external power source via a plug-in connection 20.

The energy supply element 2 is preferably a capacitor having a high capacitance. Capacitors of this type are known, for example, under the name supercapacitor. Capacitors of this type typically have a capacitance of several thousand farad. Furthermore, the capacitors can maintain said high capacitance over relatively long periods of time, such as, for example, weeks or months, since the spontaneous discharge is very small. However, the energy supply element 2 may alternatively also be any energy store. By means of the use of an energy supply element 2 which is independent of a constant supply of energy, the use of the drive system A according to the invention can be designed to be more flexible, since the costly connection of the drive system A to a mains cable is not needed.

The drive element 1 and the energy supply element 2 are preferably arranged in a common drive housing H, of which only a lower part is shown in FIG. 2. The housing H can be manufactured, for example, from plastic.

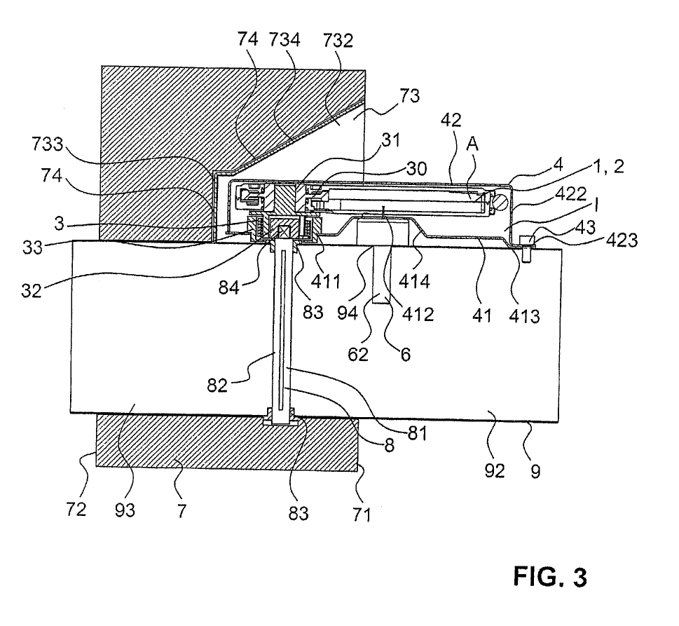

FIG. 3 shows a sectional illustration of the drive system A according to the invention which is connected to the fire protection flap 8 and the ventilation duct 9. The fire protection flap 8 substantially comprises a flap spindle 81 and a flap leaf 82. The flap spindle 81 is mounted in the ventilation duct 9 by means of flap mountings 83. Furthermore, the flap spindle 81 has a coupling 84. The flap spindle 81 can be connected to the drive system A or to the load moment block 3 by means of the coupling 84.

FIG. 3 shows that the load moment block 3 is connected to the internal toothing 31 of the gearwheel 30. The output side 32 of the load moment block 3 is connected to a rotational spindle 81 of the fire protection flap 8. Accordingly, a rotation of the electric motor 10 is passed via the transmission 11 and the load moment block 3 to the rotational spindle 81 of the fire protection flap 8.

The present drive system A can actuate the fire protection flap 8 in normal operation, for example for ventilation purposes, and therefore has the function of a ventilation flap in a ventilation duct 9. This means, in other words, that the fire protection flap 8 can be opened and closed again in normal operation on the basis of different operating states in a ventilation system. As soon as a fire develops, the fire protection flap 8 is intended to continue to be able to function reliably and is intended to be able to be closed reliably by the drive system according to the invention. At very high temperatures (for example above 1000° C.), the fire protection flap 8 is intended to be blocked in the closed state. The load moment block 3 serves to block the fire protection flap 8 in the closed state. That is to say, forces which act on the fire protection flap 8 have to be absorbed by the load moment block 3.

The fire protection flap 8 divides the ventilation duct 9 into a first compartment 92 and a second compartment 93. In the event of a fire, the fire protection flap 8 is actuated from the open position into the closed position by the drive system A. That is to say, the first compartment 92 and the second compartment 93 are separated from each other by the fire protection flap 8.

The ventilation duct 9 penetrates the wall 7. The wall 7 has a first surface 71 and a second surface 72, the first surface 71 and the second surface 72 delimiting the thickness of the wall 7. For example, the wall 7 may separate two adjacent rooms from each other, or it may be an outer wall of a building. The wall 7 constitutes a means for forming fire compartments in a building. In the event of a fire, the drive system according to the invention moves the fire protection flap from the open position into the closed position. The fire protection flap 8 in this case prevents a flashover from a first room or fire compartment to a second room or fire compartment, i.e. from the first compartment 92 to the second compartment 93.

The fire protection flap 8 is arranged in the ventilation duct 9 in such a manner that it is preferably located between the first surface 71 and the second surface 72 of the wall 7. The drive shaft 81 of the fire protection flap 8 is mounted rotatably by means of a lower and by means of an upper mounting 83 which are both arranged in the ventilation duct 9. Owing to the arrangement of the fire protection flap 8 between the first surface 71 and the second surface 72, the coupling 84 of the output shaft comes to lie in the wall 7. In order to provide access to the coupling 84, the wall 7 preferably has a niche 73 which extends into the wall 7, here into the first surface 71. The niche 73 forms a space in which the drive system A according to the invention is partially arranged. The niche 73 is bounded by a right side wall 731, a left side wall 732, a back wall 733 and a top wall 734. The right side wall 731 and the left side wall 732 preferably extend parallel to each other and parallel to the ventilation duct 9. The top wall 734 connects the right side wall 731 and the left side wall 732 and extends at an angle with respect to the center axis 91. The back wall 733 forms the rear end of the niche 73. If the wall 7 is a concrete wall, the ventilation duct 9 can be inserted into the formwork before the concrete is poured in. In addition, a niche plate 74 having the shape of the niche 73 can be connected to the ventilation duct 9 before the ventilation duct 9 is inserted into the formwork. The arrangement of the niche plate 74 results in the formation of the niche 73 when concrete is poured into the formwork.

According to the exemplary embodiment, as shown in FIG. 3, the drive element 1 of the drive system A is substantially made of plastic. Furthermore, the drive system A according to this exemplary embodiment comprises a heat protection element 4.

The expression substantially made of plastic is to be understood as meaning that a large portion of the electric motor 10 and in particular of the transmission 11 can be manufactured from plastic. This permits particularly efficient and cost-effective manufacturing. Metallic parts are preferably used only when physical properties, such as, for example, magnetism, are required on the basis of a determined function. For example, metallic parts may be present, for example, on the rotor and on the stator of the electric motor 10.

The arrangement of the heat protection element 4 delays the action of heat on the drive system A in the event of a fire.

In this exemplary embodiment, the heat protection element 4 substantially entirely surrounds the drive system A. The heat protection element 4 comprises a heat protection shield 41 and a heat protection cover 42. The heat protection shield 41 and the heat protection cover 42 are arranged in such a manner that they can be connected to each other. When joined together, the heat protection shield 41 and the heat protection cover 42 form an interior space I for receiving the housing H in which the drive element 1, the energy supply element 2 and parts of the load moment block 3 are arranged.

The heat protection shield 41 is arranged between the drive system and the ventilation duct 9. The heat protection shield 41 furthermore has at least one spindle opening 411. The rotational spindle 81 of the fire protection flap 8 can protrude through the heat protection shield 41 through the spindle opening 411.

Furthermore, the heat protection shield 41 can have further openings, such as, for example, a sensor opening 412, through which a contact pin 61 of the triggering device 6 can be supplied to the drive element 1. The contact pin 61 may also be configured as a signal conductor. A tab 413 via which the heat protection shield 41 can be connected to the ventilation duct 9 is optionally integrally formed on the heat protection shield 41. For this purpose, use is preferably made of a screw 43 which can be screwed into the duct.

The heat protection cover 42 has substantially a cuboidal shape with a base plate 421 and side walls 422. The side walls 422 preferably extend vertically from the base plate 421 and substantially completely surround the circumference of the base plate 421. A tab 423 is integrally formed on one side wall 422. The tab 423 serves to receive the screw 43 in order to connect the heat protection cover 42 to the ventilation duct 9 via the heat protection shield 41.

In an alternative embodiment, the arrangement of the heat protection cover 42 may be omitted. Accordingly, only the flat heat protection shield 41 is arranged between the drive housing H and the ventilation duct 9.

In a further alternative embodiment of the heat protection element 4, it is also conceivable for the heat protection shield 41 to be provided with side walls (not shown). The side walls protrude from the heat protection shield and extend along the circumference of the heat protection shield. The arrangement of a heat protection cover can be omitted in this embodiment. The structure of the heat protection shield can be referred to as trough-shaped. A trough-shaped body which surrounds the drive system on the side facing the ventilation duct 9 accordingly results. Furthermore, the side walls of the drive housing H are also surrounded. With a heat protection element 4 of this type, the drive housing H is particularly efficiently shielded from the ventilation pipe 9 with regard to action of heat.

The heat protection element 4 delays the action of heat on the drive system A in the event of a fire. Accordingly, an early failure of the plastic components of the drive system A according to the invention due to the action of heat is prevented. An earlier failure can be understood as meaning, for example, the melting of individual components at an early stage of the development of a fire. That is to say, the drive element 1 is capable of actuating, i.e. closing, the fire protection flap 8 at an early stage of the development of a fire. If the drive element 1 or components thereof or the energy supply element 2 were now to melt due to the development of heat over the further course of the fire, this does not have any effect on the state of the fire protection flap 8, since the latter is blocked in the preferably closed position by the load moment block 3.

According to one configuration, the heat protection element 4 has low heat conductivity. Owing to this property, the heat is only passed on very slowly by the heat protection element 4. The action of heat can therefore be delayed. It can therefore also be stated that the heat protection element 4 has a heat-insulating effect. That is to say, the drive system has a sufficient amount of time in the event of a fire in order to securely close the fire protection flap. For example, the heat protection element 4 is manufactured from calcium silicate or ceramic which have correspondingly low heat conductivities.

According to a further configuration, the heat protection element 4 has a high heat storage capacity. Owing to this property, the heat protection element 4 can absorb the heat arising in the event of a fire without the heat being passed on by the heat protection element 4 to the drive system A. In the event of a rise in temperature in the ventilation duct 9 during a fire, the heat protection element 4 serves to absorb the heat energy and therefore prevents early failure of the plastic components of the drive system A according to the invention due to the action of heat. Said element may also be referred to in this case as an absorption element because of the absorption of the heat. The heat protection element 4 can preferably be composed of a metallic material, such as, for example, steel.

As an alternative, the heat protection element 4 can also reduce or delay the exchange of heat radiation. Spreading of the fire by the drive burning is prevented or greatly delayed. In order to reduce or delay the exchange of heat radiation, the heat protection element can be manufactured, for example, from steel or aluminum.

By means of the heat protection element 4 delaying the action of heat on the drive element 1, and by means of the load moment block 3 blocking the fire protection flap 8, a reliable and reliably operating drive system A is provided. Furthermore, owing to the arrangement of the heat protection element 4 and of the load moment block 3, the drive element 1 can be configured substantially from plastic. The use of plastic instead of metallic structural elements is extremely cost-effective with regard to provision of materials and also with regard to manufacturing.

Furthermore, the drive system A according to the invention comprises a triggering device 6. The triggering device 6 may be, for example, a temperature sensor, a gas sensor, a particle sensor or a smoke sensor. The gas sensor can determine, for example, the concentration of CO₂, CO, NOx, ozone or the toxicity of a gas. The triggering device 6 detects a state, for example in the ventilation duct 9 or at another location in a room, and, with reference to predetermined parameters, emits a corresponding command to close the fire protection flap 8. A predetermined parameter could be, for example, a predetermined desired temperature or a predetermined smoke concentration in the ventilation duct 9 or at a different location in a room. The detecting of other operating states within and/or outside the duct is likewise conceivable.

An example of the arrangement of the triggering device 6 can be seen in FIG. 3. The triggering device 6 serves to emit a signal to the drive element 1 as soon as a certain state, such as, for example, the exceeding of a certain temperature, has occurred. In the present exemplary embodiment, the triggering device 6, here a temperature sensor, is arranged between the ventilation duct 9 and the drive element 1 or the heat protection element 4. For this purpose, the heat protection element 4, in particular the heat protection shield 41, has a corresponding indentation 414.

Contact pins 61 protrude from the triggering device 6 such that they can be connected to the drive element 1 by corresponding contact points. In this case, the contact pins 61 and the contact points are preferably configured in such a manner that the contact pins 61 can be inserted into the contact points. Said plug-in connection permits a particularly simple connection between the drive element 1 and triggering device 6. Said contact pins 61 can protrude through sensor openings 412 in the heat protection shield 41 into the interior space I provided by the heat protection element 4.

A measuring member 62 which protrudes from the triggering device projects through a measuring opening 94 into the ventilation duct 9. Said measuring member 62 serves to record the operating state, i.e., for example, to record the temperature or the smoke concentration, in the ventilation duct 9.

FIG. 3 also shows a possible torque support 33 for the load moment block 3. A torque support 33 is understood here as meaning an element which can absorb a torque acting on the load moment block 3. In this exemplary embodiment, the torque support 33 is connected to the spindle opening 411 in the heat protection shield 41. Since the heat protection shield 41 is connected to the ventilation duct 9 via a screw 43, the torque resulting from the ventilation flap 9 is absorbed by the heat protection shield 41 or by the screw 43.

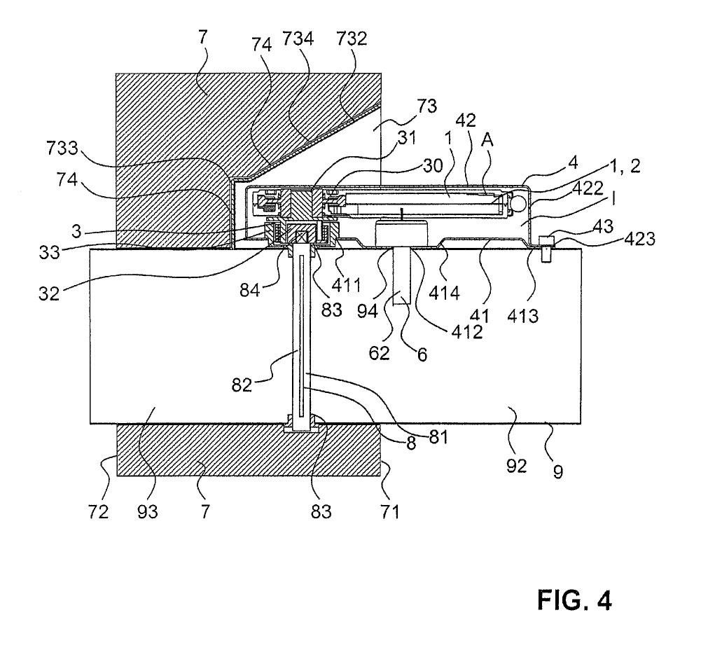

FIG. 4 shows a further configuration of the heat protection element 4 and of the arrangement of the triggering device 6. In this exemplary embodiment, the triggering device 6 is arranged between the drive element 1 and the heat protection shield 41. That is to say, in other words, that the triggering device 6 is arranged in the interior space I of the heat protection element 4. The heat protection element is preferably connected to the ventilation duct by means of a screw 43.

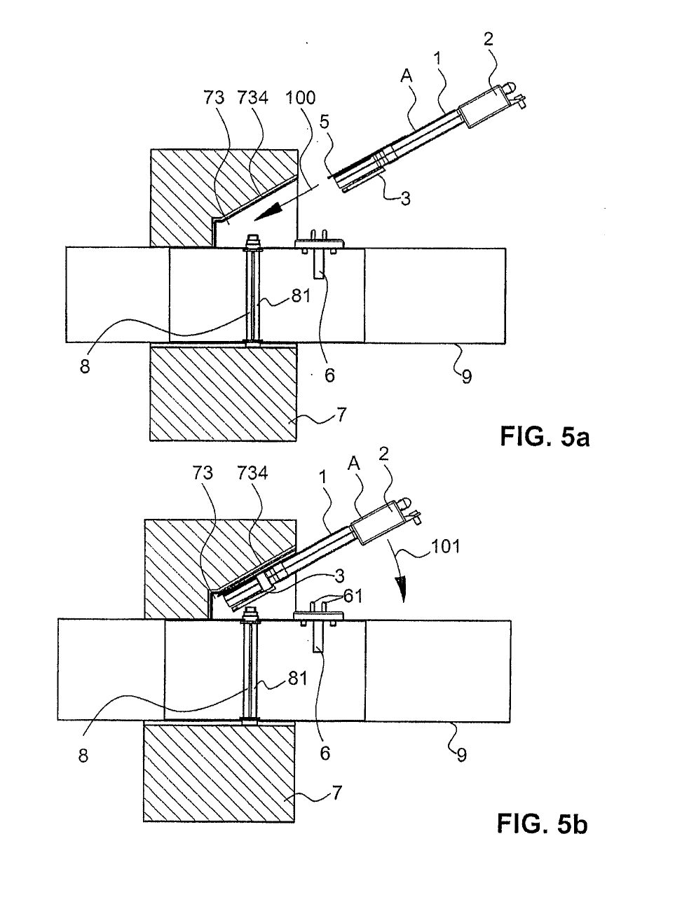

FIGS. 5a to 5c show the installation of the drive system according to the invention. It is shown in FIG. 5a that the drive system A is positioned at an angle to the ventilation duct 9 before the connection to the rotational spindle 81 of the fire protection flap 8. The drive system A is pushed into the niche 73 in the direction of the arrow 100, which direction can be referred to as the pushing-in direction.

FIG. 5b shows the drive system A located in the niche 73, the drive system A being arranged here substantially parallel to the top wall 734 of the niche. As soon as the drive system A is pushed into the niche 73 to an extent such that the output side 32 of the load moment block 3 comes to lie against the coupling 84 of the flap 8, the drive system A can be pivoted in the direction of the ventilation duct 9. This is illustrated by an arrow 101.

By means of the pivoting movement of the drive system A in the direction of the ventilation duct 9, the drive system A can be connected to the rotational spindle 81 of the fire protection flap 8 and to the contact pins 61 of the triggering device 6. By means of the pivoting movement of the drive system A and by means of a suitable configuration of the coupling between the load moment block 3 and flap spindle 81, the drive system A can be fitted in a simple manner.

FIG. 5c shows the drive system A fitted on the ventilation duct 9.

Furthermore, FIG. 5c shows a further variant for the torsional locking of the drive system A. Torques which act on the drive system A have to be compensated for by suitable mechanical means. For example, “torsional locking means” can be arranged for this. Such a torque can result, for example, from forces which act on the drive flap 8 and, via the load moment block 3, on the drive system A. Furthermore, a torque results by means of the drive element 1 of the drive system A. A torsional locking element can be arranged to absorb such a torque, the torsional locking element blocking a movement of the drive relative to the ventilation duct 9.

According to the exemplary embodiment shown in FIG. 5c, the torsional locking element can be configured as a sheet metal element 5. The sheet metal element 5 is fixedly connected to the drive system A. The sheet metal element 5 preferably makes contact with the left side wall 731 and/or the right side wall 732 of the niche 73. The torque is accordingly conducted onto the niche 73 via the sheet metal element 5. As an alternative, the sheet metal element 5 can also be connected to the heat protection element 4.

The sheet metal element 5 is not shown in FIG. 3. The sheet metal element can alternatively be fixedly connected to the heat protection element 4. The elements, which are mentioned in the description, of the individual exemplary embodiments can be combined in different ways. It is possible in particular to combine individual features shown in the respective exemplary embodiments with individual features from other exemplary embodiments. In particular, for example, the plastic drive and the heat protection element can be combined with the supercapacitor and/or the torsional locking element. As an alternative, a configuration is also conceivable which combines the supercapacitor with the torsional locking element.

According to a further exemplary embodiment, the torsional locking element can be configured, for example, as a screw 43. This is illustrated in FIG. 3. The screw 43 is preferably arranged at a position as far away as possible from the rotational spindle 81 of the fire protection flap 8. As an alternative, the screw 43 can serve at the same time as a fastening element of the heat protection element 4.

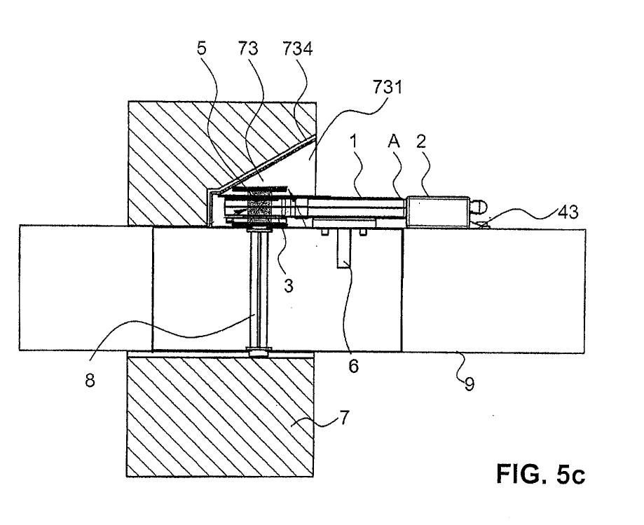

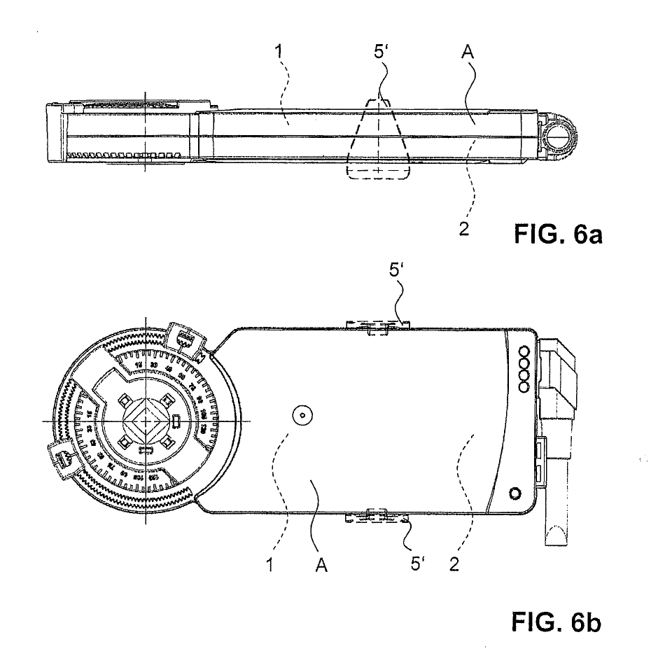

FIGS. 6a and 6b show a further embodiment of the torsional locking means which is configured here as a tab 5′. A respective tab 5′ is preferably arranged on the left and right of the drive system A. The tab 5′ is connected to the ventilation duct.

### LIST OF DESIGNATIONS

A Drive system
H Housing
1 Drive element
2 Energy supply element
3 Load moment block
4 Heat protection element
5 Sheet metal element
6 Triggering device
7 Wall
8 Fire protection flap
9 Ventilation duct
10 Electric motor
11 Transmission
12 Transmission input side
13 Transmission output side
20 Plug-in connection
30 Gearwheel
31 Internal toothing
32 Output side of the load moment block
33 Torque support
41 Heat protection shield
411 Spindle opening
412 Sensor opening
413 Tab
42 Heat protection cover
421 Base plate
422 Side wall
423 Tab
43 Fastening screw
61 Contact pins
62 Measuring member
71 First surface
72 Second surface
73 Niche
731 Right side wall
732 Left side wall
733 Back wall
734 Top wall
74 Niche plate
81 Rotational spindle
82 Flap leaf
83 Mounting of the flap
84 Coupling
91 Center axis
92 First compartment
93 Second compartment
94 Measuring opening
100 Pushing-in direction
101 Pivoting direction

1-14. (canceled)

15. A drive system for a fire protection flap arranged in a ventilation duct, comprising:
at least one drive element, the drive element being substantially made of plastic;
a heat protection element located at least on a side of the drive element facing the ventilation duct;
an energy supply element for supplying energy to the drive element; and
a mechanical load moment block for absorbing a torque acting on the fire protection flap.

16. The drive system as claimed in claim 15, wherein the drive element comprises at least one electric motor and at least one transmission.

17. The drive system as claimed in claim 15, wherein the heat protection element comprises a heat protection shield.

18. The drive system as claimed in claim 17, wherein the heat protection element comprises side walls protruding from the heat protection shield.

19. The drive system as claimed in claim 17, wherein the heat protection element furthermore comprises a heat protection cover, the heat protection shield and the heat protection cover forming an interior space in which at least the drive element of the drive system is arranged.

20. The drive system as claimed in claim 15, wherein a triggering device is provided between the ventilation duct and the drive element.

21. The drive system as claimed in claim 20, wherein the triggering device comprises contact pins for connecting the triggering device in a plug-in manner to elements of the drive system.

22. The drive system as claimed in claim 20, wherein the triggering device comprises contact pins for connecting the triggering device in a plug-in manner to the electric motor of the drive element.

23. The drive system as claimed in claim 20, wherein the triggering device is a sensor selected from the group consisting of temperature sensors, gas sensors, particle sensors, and smoke sensors.

24. The drive system as claimed in claim 15, wherein the drive system is adapted to be fitted via an angular movement relative to the ventilation duct.

25. A drive system for a fire protection flap arranged in a ventilation duct, comprising:
at least one drive element;
an energy supply element for supplying energy to the drive element;
a mechanical load moment block for absorbing a torque acting on the fire protection flap; and
a torsional locking element fixedly connected to a part of the drive element, the torsional locking element being arranged to protrude on an element which is connected to the ventilation duct in order to lock the drive element torsionally.

26. The drive system as claimed in claim 25, wherein said part is the drive element.

27. The drive system as claimed in claim 25, wherein the element which is connected to the ventilation duct is a niche in a wall, the torsional locking element abutting to said niche.

28. The drive system (A) as claimed claim 25, wherein the torsional locking element is configured as a sheet metal element or as a tab.

29. The drive system as claimed in claim 25, wherein a triggering device is provided between the ventilation duct and the drive element.

30. The drive system as claimed in claim 29, wherein the triggering device comprises contact pins for connecting the triggering device in a plug-in manner to elements of the drive system.

31. The drive system as claimed in claim 29, wherein the triggering device comprises contact pins for connecting the triggering device in a plug-in manner to the electric motor of the drive element.

32. The drive system as claimed in claim 29, wherein the triggering device is a sensor selected from the group consisting of temperature sensors, gas sensors, particle sensors, and smoke sensors.

33. The drive system as claimed in claim 25, wherein the drive system is adapted to be fitted via an angular movement relative to the ventilation duct.

34. A drive system for a fire protection flap arranged in a ventilation duct, comprising:
at least one drive element;
an energy supply element for supplying energy to the drive element, the energy supply element being a supercapacitor; and
a mechanical load moment block for absorbing a torque acting on the fire protection flap.

35. The drive system as claimed in claim 34, wherein a triggering device is provided between the ventilation duct and the drive element.

36. The drive system as claimed in claim 35, wherein the triggering device comprises contact pins for connecting the triggering device in a plug-in manner to elements of the drive system.

37. The drive system as claimed in claim 35, wherein the triggering device comprises contact pins for connecting the triggering device in a plug-in manner to the electric motor of the drive element.

38. The drive system as claimed in claim 35, wherein the triggering device is a sensor selected from the group consisting of temperature sensors, gas sensors, particle sensors, and smoke sensors.

39. The drive system as claimed in claim 34, wherein the drive system is adapted to be fitted via an angular movement relative to the ventilation duct.
